(19) United States
(12) Patent Application Publication
(10) Pub. No.: US 2024/0330802 A1
(43) Pub. Date: Oct. 3, 2024

(54) METHOD, INFORMATION PROCESSING DEVICE, AND PROGRAM

(71) Applicant: TOYOTA JIDOSHA KABUSHIKI KAISHA, Toyota-shi (JP)

(72) Inventors: Motohiro NAKAMURA, Okazaki-shi (JP); Hiroto TOMIDA, Tokyo (JP); Jean-Sebastien BOIRE, Yokohama-shi (JP); Ryusaku YAMAMOTO, Tokyo (JP); Kohei WATANABE, Tokyo (JP)

(73) Assignee: TOYOTA JIDOSHA KABUSHIKI KAISHA, Toyota-shi (JP)

(21) Appl. No.: 18/616,566

(22) Filed: Mar. 26, 2024

(30) Foreign Application Priority Data
Mar. 31, 2023 (JP) 2023-059349

(51) Int. Cl. G06Q 10/0631; G06Q 10/083

(52) U.S. Cl. CPC G06Q 10/06312; G06Q 10/083

(57) ABSTRACT

A method executed by an information processing device to assign to a target vehicle a task of delivering loads stored in a warehouse and addressed to a target consignee includes executing an assignment process. The assignment process includes: determining whether a load amount of the loads is a reference amount or more; when the load amount is less than the reference amount, assigning the task to the target vehicle; when the load amount is less than the reference amount, determining whether a target time as a time from a predicted end time of the task to an operation end time of the target vehicle is within a reference time; when the target time is within the reference time, assigning the task to the target vehicle; and when the target time is not within the reference time, withholding assignment of the task to the target vehicle.

### CROSS-REFERENCE TO RELATED APPLICATION

This application claims priority to Japanese Patent Application No. 2023-059349 filed on Mar. 31, 2023, incorporated herein by reference in its entirety.

### BACKGROUND

### 1. Technical Field

The present disclosure relates to a method, an information processing device, and a program.

### 2. Description of Related Art

There has hitherto been known a distribution system that delivers loads stored in a warehouse to a consignee. For example, WO 2020/054490 discloses a distribution system that assigns loads in a distribution warehouse to a delivery vehicle, in which the distribution warehouse is instructed to make preparations according to a preparation plan for putting the loads into storage or taking the loads out of storage, and the delivery vehicle is notified of delay information when delay in the preparations from the preparation plan is detected.

### SUMMARY

Improvements in the delivery efficiency in distribution systems are desired. In the conventional distribution system, for example, it is a common practice to withhold the work of loading the delivery vehicle until a certain amount of loads is accumulated in the distribution warehouse, in order to improve the delivery efficiency by increasing the amount of loads to be delivered by the delivery vehicle at a time. However, if the operation time of the delivery vehicle is ended before the certain amount of loads is accumulated in the distribution warehouse, for example, delivery of such loads may be delayed to the next day, which may lower the delivery efficiency as a whole.

The present disclosure provides a method, an information processing device, and a program that improve the delivery efficiency of a distribution system.

An aspect of the present disclosure provides a method executed by an information processing device to assign to a target vehicle a task of delivering loads stored in a warehouse and addressed to a target consignee to the target consignee, the method including executing an assignment process including: determining whether a load amount of the loads is equal to or more than a reference amount; when the load amount is determined to be equal to or more than the reference amount, assigning the task to the target vehicle; when the load amount is determined to be less than the reference amount, determining whether a target time as a time from a predicted end time of the task to an operation end time of the target vehicle is within a reference time; when the target time is determined to be within the reference time, assigning the task to the target vehicle; and when the target time is determined not to be within the reference time, withholding assignment of the task to the target vehicle.

An aspect of the present disclosure provides an information processing device that assigns to a target vehicle a task of delivering loads stored in a warehouse and addressed to a target consignee to the target consignee, the information processing device including a control unit configured to execute an assignment process including: determining whether a load amount of the loads is equal to or more than a reference amount; when the load amount is determined to be equal to or more than the reference amount, assigning the task to the target vehicle; when the load amount is determined to be less than the reference amount, determining whether a target time as a time from a predicted end time of the task to an operation end time of the target vehicle is within a reference time; when the target time is determined to be within the reference time, assigning the task to the target vehicle; and when the target time is determined not to be within the reference time, withholding assignment of the task to the target vehicle.

An aspect of the present disclosure provides a program that causes an information processing device to execute an assignment process, the information processing device assigning to a target vehicle a task of delivering loads stored in a warehouse and addressed to a target consignee to the target consignee, the assignment process including: determining whether a load amount of the loads is equal to or more than a reference amount; when the load amount is determined to be equal to or more than the reference amount, assigning the task to the target vehicle; when the load amount is determined to be less than the reference amount, determining whether a target time as a time from a predicted end time of the task to an operation end time of the target vehicle is within a reference time; when the target time is determined to be within the reference time, assigning the task to the target vehicle; and when the target time is determined not to be within the reference time, withholding assignment of the task to the target vehicle.

According to an embodiment of the present disclosure, the delivery efficiency of a distribution system is improved.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is a block diagram illustrating a schematic configuration of an information processing device according to an embodiment of the present disclosure;

FIG. 2 illustrates a specific example of a consignee list stored in the information processing device;

FIG. 3 illustrates a specific example of a vehicle list stored in the information processing device; and

FIG. 4 is a flowchart illustrating operation of the information processing device.

### DETAILED DESCRIPTION OF EMBODIMENTS

An embodiment of the present disclosure will be described below.

### Overview of Embodiment

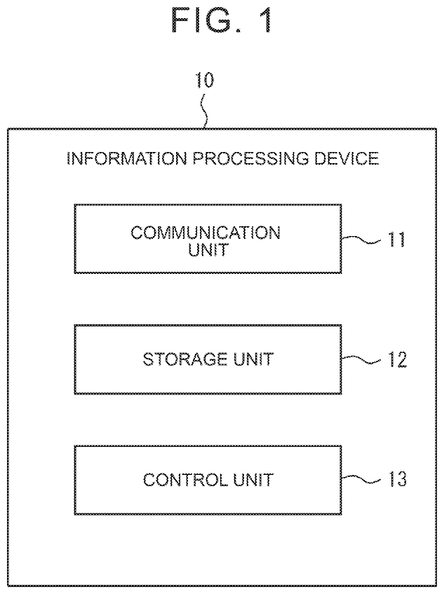

An overview of an information processing device 10 according to an embodiment of the present disclosure will be described with reference to FIG. 1. The information processing device 10 is a computer such as a personal computer (PC) or a server, for example. In the present embodiment, the information processing device 10 is used to provide a distribution service.

In a common distribution service, loads to be delivered to a consignee such as a shop are put into storage in a warehouse. The loads put into storage in a distribution warehouse are temporarily stored. When a certain amount of loads to be delivered to the consignee is accumulated, a task of delivering the loads to the consignee is assigned to a delivery vehicle such as a truck. A worker such as a driver of the delivery vehicle, for example, loads the loads onto the delivery vehicle in the distribution warehouse, and delivers the loads to the consignee. When delivery of the loads is completed, the task is ended. In a common distribution service, the task of delivering loads is managed in this manner.

First, an overview of the present embodiment will be described, and the details thereof will be discussed later. The information processing device 10 is used to assign to a target vehicle a task of delivering loads stored in a warehouse and addressed to a target consignee to the target consignee. The information processing device 10 executes an assignment process including a plurality of steps. Specifically, the assignment process includes: determining whether a load amount of the loads is equal to or more than a reference amount; when the load amount is determined to be equal to or more than the reference amount, assigning the task to the target vehicle; when the load amount is determined to be less than the reference amount, determining whether a target time as a time from a predicted end time of the task to an operation end time of the target vehicle is within a reference time; when the target time is determined to be within the reference time, assigning the task to the target vehicle; and when the target time is determined not to be within the reference time, withholding assignment of the task to the target vehicle.

In the present embodiment, in this manner, assignment of the task to the target vehicle is basically withheld when the load amount of loads in the warehouse is less than the reference amount, while the task is exceptionally assigned to the target vehicle when the target time is within the reference time. In other words, in the present embodiment, assignment of the task is basically withheld until loads in the reference amount or more are accumulated when the amount of loads accumulated in the warehouse is less than the reference amount. On the other hand, the task is exceptionally assigned when the predicted end time at which the task is expected to be ended is close to the operation end time of the target vehicle, even when the amount of loads accumulated in the warehouse is less than the reference amount. Thus, according to the present embodiment, the delivery efficiency may be improved as a whole, since the probability of a disadvantageous occurrence in which delivery of loads in an amount less than the reference amount accumulated in the warehouse is delayed to the next day as a result of the operation time of the target vehicle being ended before loads in the reference amount or more are accumulated in the warehouse, for example.

### Configuration of Information Processing Device

Next, constituent elements included in the information processing device 10 will be described in detail. As illustrated in FIG. 1, the information processing device 10 includes a communication unit 11, a storage unit 12, and a control unit 13.

The communication unit 11 includes one or more communication interfaces connected to a network such as the Internet, for example. The communication interface supports communication standards such as, but not limited to, a mobile communication standard such as fourth generation (4G) and fifth generation (5G), a wired local area network (LAN) standard, and a wireless LAN standard, for example, and may support any communication standard. The communication unit 11 may further include a communication interface that directly communicates with an external device. The communication interface supports short-range wireless communication standards such as, but not limited to, infrared rays and Bluetooth (registered trademark), for example, and may support any communication standard.

The storage unit 12 includes one or more memories. The memory may be, but is not limited to, a semiconductor memory, a magnetic memory, an optical memory, etc., for example. The memory included in the storage unit 12 may function as a main storage device, an auxiliary storage device, or a cache memory, for example. The storage unit 12 stores any information that is used for operation of the information processing device 10. For example, the storage unit 12 may store a system program, an application program, etc. In the present embodiment, the storage unit 12 stores a consignee list and a vehicle list to be discussed later.

The control unit 13 includes one or more processors, one or more programmable circuits, one or more dedicated circuits, or a combination of these. The processor may be, but is not limited to, a general-purpose processor such as a central processing unit (CPU) or a graphics processing unit (GPU), or a dedicated processor specialized for a specific process, for example. The programmable circuit may be, but is not limited to, a field-programmable gate array (FPGA), for example. The dedicated circuit may be, but is not limited to, an application specific integrated circuit (ASIC), for example. The control unit 13 controls operation of the entire information processing device 10. For example, the control unit 13 consecutively updates a consignee list and a vehicle list to be discussed later. Further, the control unit 13 executes an assignment process to be discussed later, for example.

### Details of Consignee List

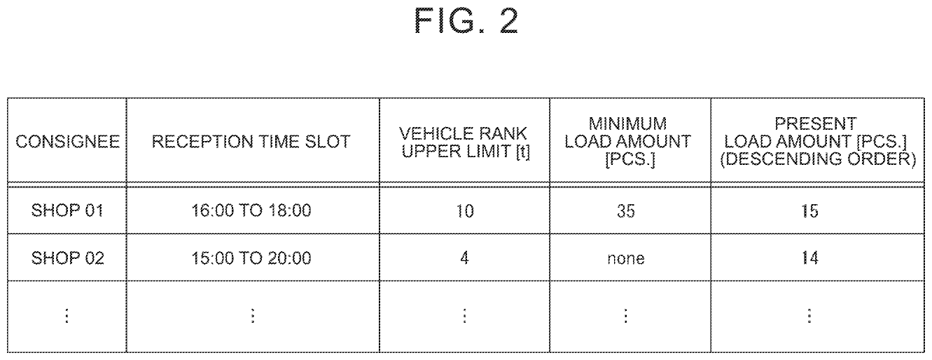

The consignee list stored in the storage unit 12 is a list that includes any information about consignees. In the example illustrated in FIG. 2, information on each consignee is indicated in each row of the consignee list. Specifically, the consignee list includes four items, namely “reception time slot”, “vehicle rank upper limit”, “minimum load amount”, and “present load amount”, for each consignee.

The “reception time slot” is the time slot for which the consignee allows arrival of delivery vehicles. The reception time slot may be set by an operator according to the consignee. For example, the reception time slot may be set for a shop in a shopping mall etc. as a time slot for performing the work of receiving delivered loads when such a time slot is determined. For example, when loads are delivered to shop 01 indicated in FIG. 2, it is desirable that the delivery vehicle should arrive at the shop 01 between 16:00 and 18:00.

The “vehicle rank upper limit” is the upper limit of the vehicle rank of delivery vehicles that can be received by the consignee. In the present embodiment, the vehicle rank is indicated by the maximum loading capacity [t] of the delivery vehicle. However, this is not limiting, and the vehicle rank may be indicated by the class such as “small”, “medium”, and “large”, for example. The vehicle rank upper limit may be set by an operator according to the consignee. For example, the vehicle rank upper limit may be set for a shop in a shopping mall etc. when the size of vehicles that can enter a parking lot is limited because of the facility structure. For example, when loads are delivered to shop 01 indicated in FIG. 2, it is desirable that the maximum loading capacity should be 10 t or less.

The “minimum load amount” is the lower limit value of the load amount of loads allowed to be received by the consignee in one delivery. In the present embodiment, the load amount is indicated by the number of loads. However, this is not limiting, and the load amount may be indicated by the weight etc., for example. The minimum load amount may be set by an operator according to the consignee. For example, the minimum load amount may be set for a shop in a shopping mall etc. when it is desirable to collectively receive a certain amount of loads or more in one delivery in order to improve the efficiency of the work of receiving delivered loads. For example, when loads are delivered to shop 01 indicated in FIG. 2, it is desirable that 35 loads or more should be delivered in one delivery.

The “present load amount” is the load amount of loads temporarily stored in the warehouse. The present load amount may be updated each time loads are put into storage in the warehouse. For example, when a worker that has put loads into storage in the warehouse inputs the load amount of such loads to a terminal device such as a handy terminal, information that indicates the load amount is transmitted from the terminal device to the information processing device 10 to update the present load amount. However, update of the present load amount is not limited to this example, and any method may be employed to update the present load amount.

In the consignee list according to the present embodiment, the information on the consignees is arranged in the descending order of the present load amount. In the consignee list illustrated in FIG. 2, information on shop 01 with a present load amount of 15 is indicated in the first row, and information on shop 02 with a present load amount of 14 is indicated in the second row. However, the order of arrangement of the consignees may be varied if the present load amount is updated according to factors such as putting loads into storage, taking loads out of storage, etc., for example.

The items included in the consignee list are not limited to those in the example discussed above. For example, the consignee list may further include an item that indicates the address of the consignee.

### Details of Vehicle List

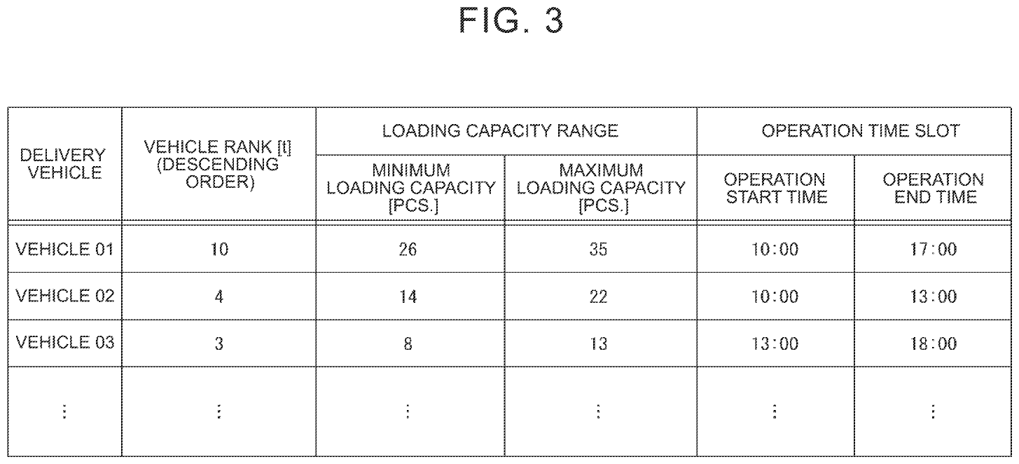

The vehicle list stored in the storage unit 12 is a list that includes any information about delivery vehicles as candidates for task assignment. In the example illustrated in FIG. 3, information on each delivery vehicle is indicated in each row of the vehicle list. Specifically, the vehicle list includes three items, namely “vehicle rank”, “loading capacity range”, and “operation time slot”, for each delivery vehicle.

The “vehicle rank” is the vehicle rank of the delivery vehicle. In the present embodiment, as discussed above, the vehicle rank is indicated by the maximum loading capacity [t] of the delivery vehicle.

The “loading capacity range” includes two sub items, namely “minimum loading capacity” and “maximum loading capacity”. The “minimum loading capacity” is the lower limit value of the load amount of loads delivered by the delivery vehicle in one delivery. The “maximum loading capacity” is the upper limit value of the load amount of loads delivered by the delivery vehicle in one delivery. The minimum loading capacity and the maximum loading capacity may be automatically set according to the vehicle rank of the delivery vehicle, or may be set as desired by an operation according to the driver of the delivery vehicle. For example, the minimum loading capacity may be set when it is desirable to collectively deliver a certain amount of loads or more in one delivery in order to improve the efficiency of the delivery work. When assigning a task to a delivery vehicle, it is desirable that the load amount of loads related to the task should be within the loading capacity range (i.e. the minimum loading capacity or more and the maximum loading capacity or less).

The “operation time slot” includes two sub items, namely “operation start time” and “operation end time”. The “operation start time” is the time at which the driver of the delivery vehicle starts delivery work. The “operation end time” is the time at which the driver of the delivery vehicle ends delivery work. The operation time slot may include overtime hours allowed for the work of the driver of the delivery vehicle. When assigning a task to a delivery vehicle, it is desirable that the time since a predicted start time until a predicted end time of the work related to the task should be included in the operation time slot (i.e. between the operation start time and the operation end time).

In the vehicle list according to the present embodiment, the information on the delivery vehicles is arranged in the descending order of the vehicle rank. In the vehicle list illustrated in FIG. 3, information on vehicle 01 with a vehicle rank of 10 t is indicated in the first row, information on vehicle 02 with a vehicle rank of 4 t is indicated in the second row, and information on vehicle 03 with a vehicle rank of 3 t is indicated in the third row.

When a task is assigned to a delivery vehicle, information on the delivery vehicle may be excluded from the vehicle list until the task is finished.

The items included in the vehicle list are not limited to those in the example discussed above. For example, the vehicle list may further include an item that indicates the present position of the delivery vehicle. The present position of the delivery vehicle may be regularly acquired from the delivery vehicle via the communication unit 11, for example.

### Operation of Information Processing Device

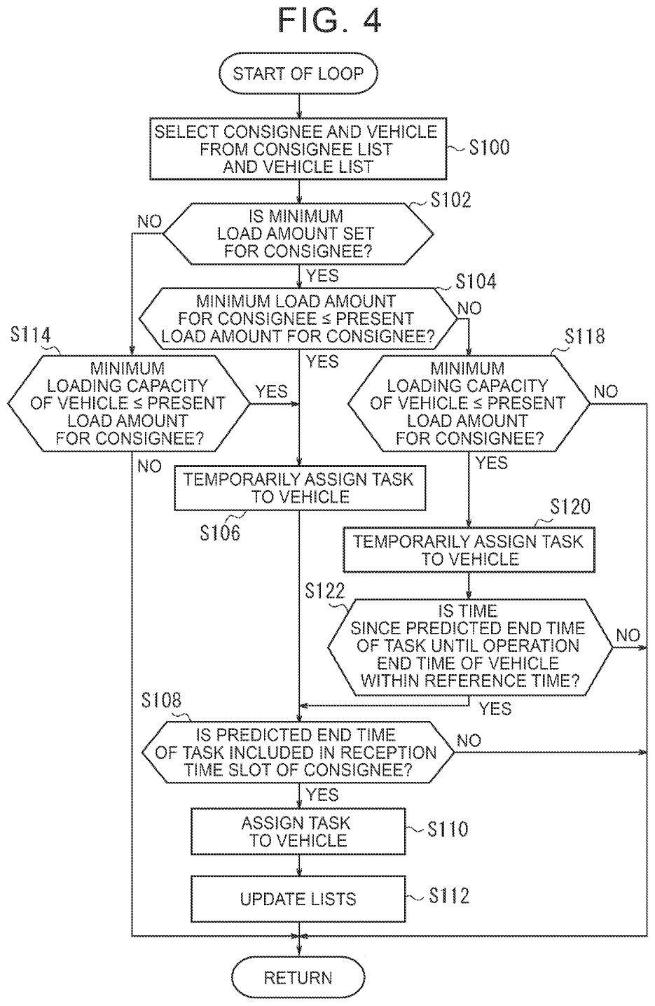

Operation of the information processing device 10 to execute an assignment process will be described with reference to FIG. 4. The assignment process includes a plurality of steps indicated in FIG. 4. The assignment process is a loop process repeatedly executed until a task of delivering loads addressed to a certain consignee is assigned to any delivery vehicle.

Step S100: The control unit 13 of the information processing device 10 selects one of a plurality of delivery vehicles included in the vehicle list stored in the storage unit 12 as a target vehicle. In addition, the control unit 13 selects one of a plurality of consignees included in the consignee list stored in the storage unit 12 as a target consignee.

Specifically, in S100, when the loop count of the assignment process is an initial value (first time), the control unit 13 may select one of the delivery vehicles with the highest vehicle rank as a target vehicle, and select one of the consignees with the largest present load amount as a target consignee.

As discussed later, when assignment of a task of delivering loads addressed to the target consignee to the target vehicle is withheld in step S100 and the subsequent steps, the control unit 13 increments the loop count and executes the assignment process again from step S100. When a task is assigned to the target vehicle, on the other hand, the control unit 13 updates the vehicle list and the consignee list, resets the loop count to the initial value (first time), and executes the assignment process again from step S100.

When the loop count of the assignment process is two or more in step S100 (i.e. when assignment of a task to the target vehicle is withheld in the preceding assignment process), the control unit 13 may select a delivery vehicle with the highest vehicle rank next to the target vehicle in the preceding assignment process as a new target vehicle. In such a case, the control unit 13 selects the same consignee as the target consignee in the preceding assignment process as a new target consignee.

Alternatively, when the loop count of the assignment process is two or more in step S100, the control unit 13 may select a consignee with the largest present load amount next to the target consignee in the preceding assignment process as a new target consignee. In such a case, the control unit 13 selects the same delivery vehicle as the target vehicle in the preceding assignment process as a new target vehicle.

Step S102: The control unit 13 determines whether a minimum load amount is set for the target consignee with reference to the consignee list. When a determination is made that a minimum load amount is set (step S102: Yes), the process proceeds to step S104. When a determination is made that a minimum load amount is not set (step S102: No), on the other hand, the process proceeds to step S114.

Step S104: When it is determined in step S102 that a minimum load amount is set (step S102: Yes), the control unit 13 determines whether the present load amount for the target consignee is equal to or more than a reference amount (the minimum load amount in the present embodiment). When the present load amount is determined to be equal to or more than the reference amount (step S104: Yes), the process proceeds to step S106. When the present load amount is determined to be less than the reference amount (step S104: No), on the other hand, the process proceeds to step S118.

Step S106: When it is determined in step S104 that the present load amount is equal to or more than the reference amount (step S104: Yes), or when it is determined in step S114 to be discussed later that the present load amount is equal to or more than the minimum loading capacity of the target vehicle (step S114: Yes), the control unit 13 temporarily assigns a task of delivering loads stored in the warehouse and addressed to the target consignee to the target vehicle.

“Temporarily assigning a task” includes a process of determining, on the assumption that the task is assigned to a target vehicle, a predicted value of the start time of the task, a predicted value of the end time of the task, and the load amount of loads to be loaded onto the target vehicle to be delivered. Hereinafter, the “predicted value of the start time” and the “predicted value of the end time” are also referred to as “predicted start time” and “predicted end time”, respectively. In addition, the “load amount of loads to be loaded onto the target vehicle to be delivered” is also referred to as “delivery load amount”.

Any method may be employed to determine the predicted start time and the predicted end time of a task. For example, a task includes the work of loading loads and the work of transporting loads from a warehouse to the address of a consignee. The control unit 13 calculates a first work time required for the loading work based on the present load amount. The control unit 13 searches for a route using the position of the warehouse and the address of the target consignee, and calculates a second work time required for the transporting work. The control unit 13 calculates the total of the first work time and the second work time as a prosecution time required from the start to the end of the task. The control unit 13 determines a first time included in the operation time slot of the target vehicle as the predicted start time. The control unit 13 determines a second time included in the operation time slot of the target vehicle and the prosecution time later than the predicted start time as the predicted end time.

In addition, the delivery load amount may be determined as desired within the range of the minimum load amount for the target consignee or more and the maximum loading capacity of the target vehicle or less.

Step S108: After step S106 or when it is determined in step S122 to be discussed later that a target time as a time since the predicted end time of the task until the operation end time of the vehicle is within a predetermined reference time (step S122: Yes), the control unit 13 determines whether the predicted end time of the task is included in the reception time slot of the target consignee. When the predicted end time is determined to be included in the reception time slot (step S108: Yes), the process proceeds to step S110. When the predicted end time is not included in the reception time slot (step S108: No), on the other hand, the control unit 13 withholds assignment of the task to the target vehicle, and increments the loop count. After that, the process returns to step S100.

Step S110: When it is determined in step S108 that the predicted end time is included in the reception time slot (step S108: Yes), the control unit 13 assigns the task to the target vehicle.

Specifically, the control unit 13 determines an operation plan of the target vehicle such that the driver of the target vehicle prosecutes the task. Then, the control unit 13 notifies a terminal device of the driver of the target vehicle of the operation plan via the communication unit 11. The “operation plan” includes any information required to prosecute the task. For example, the operation plan includes information that indicates the predicted start time, the address of the target consignee, and the predicted end time. The operation plan may further include information that indicates identification information on loads addressed to the target consignee, the delivery load amount, the location of storage of loads in the warehouse, etc. The driver of the target vehicle may prosecute the task according to the operation plan that the driver is notified of.

Step S112: The control unit 13 updates the consignee list and the vehicle list, and resets the loop count to the initial value (first time). After that, the process returns to step S100.

Specifically, the control unit 13 decreases the present load amount for the target consignee by the delivery load amount related to the task assigned to the target vehicle. In addition, the control unit 13 excludes information on the target vehicle from the vehicle list until the task assigned to the target vehicle is ended.

Step S114: When it is determined in step S102 that a minimum load amount is not set (step S102: No), the control unit 13 determines whether the present load amount for the target consignee is equal to or more than the minimum loading capacity of the target vehicle. When the present load amount is determined to be equal to or more than the minimum loading capacity (step S114: Yes), the process proceeds to step S106. When the present load amount is determined to be less than the minimum loading capacity (step S114: No), on the other hand, the control unit 13 withholds assignment of the task to the target vehicle, and increments the loop count. After that, the process returns to step S100.

Step S118: When it is determined in step S104 that the present load amount is less than the reference amount (step S104: No), the control unit 13 determines whether the present load amount for the target consignee is equal to or more than the minimum loading capacity of the target vehicle. When the present load amount is determined to be equal to or more than the minimum loading capacity (step S118: Yes), the process proceeds to step S120. When the present load amount is determined to be less than the minimum loading capacity (step S118: No), on the other hand, the control unit 13 withholds assignment of the task to the target vehicle, and increments the loop count. After that, the process returns to step S100.

Step S120: When it is determined in step S118 that the present load amount is equal to or more than the minimum loading capacity of the target vehicle (step S118: Yes), the control unit 13 temporarily assigns the task of delivering loads stored in the warehouse and addressed to the target consignee to the target vehicle.

Step S122: The control unit 13 determines whether the target time as a time since the predicted end time of the task until the operation end time of the vehicle is within a predetermined reference time. When the target time is determined to be equal to or less than the reference time (step S122: Yes), the process proceeds to step S108. When the target time is determined not to be within the reference time (step S122: No), on the other hand, the control unit 13 withholds assignment of the task to the target vehicle, and increments the loop count. After that, the process returns to step S100.

As discussed above, the information processing device 10 according to the present embodiment is used to assign to a target vehicle a task of delivering loads stored in a warehouse and addressed to a target consignee to the target consignee. The information processing device 10 executes an assignment process including a plurality of steps. Specifically, the assignment process includes: determining whether a load amount of the loads is equal to or more than a reference amount; when the load amount is determined to be equal to or more than the reference amount, assigning the task to the target vehicle; when the load amount is determined to be less than the reference amount, determining whether a target time as a time from a predicted end time of the task to an operation end time of the target vehicle is within a reference time; when the target time is determined to be within the reference time, assigning the task to the target vehicle; and when the target time is determined not to be within the reference time, withholding assignment of the task to the target vehicle.

With such a configuration, assignment of the task to the target vehicle is basically withheld when the load amount of loads in the warehouse is less than the reference amount, while the task is exceptionally assigned to the target vehicle when the target time is within the reference time. In other words, in the present embodiment, assignment of the task is basically withheld until loads in the reference amount or more are accumulated when the amount of loads accumulated in the warehouse is less than the reference amount. On the other hand, the task is exceptionally assigned when the predicted end time at which the task is expected to be ended is close to the operation end time of the target vehicle, even when the amount of loads accumulated in the warehouse is less than the reference amount. Thus, according to the present embodiment, the delivery efficiency may be improved as a whole, since the probability of a disadvantageous occurrence in which delivery of loads in an amount less than the reference amount accumulated in the warehouse is delayed to the next day as a result of the operation time of the target vehicle being ended before loads in the reference amount or more are accumulated in the warehouse, for example.

While the present disclosure has been described above based on the drawings and the embodiment, it should be noted that a person skilled in the art may make various modifications and alterations thereto based on the present disclosure. It should therefore be understood that these modifications and alterations are within the scope of the present disclosure. For example, the functions included in the components, steps, etc. can be rearranged so as not to be logically inconsistent, and a plurality of components, steps, etc. can be combined into one or divided into sub-components, sub-steps, etc.

For example, in the embodiment discussed above, the configuration and operation of the information processing device 10 may be distributed among a plurality of computers that can communicate with each other.

An embodiment is also possible in which a general-purpose computer, for example, is caused to function as the information processing device 10 according to the above embodiment. Specifically, a program describing processing contents for implementing the functions of the information processing device 10 according to the above embodiment is stored in a memory of the general-purpose computer, and the program is read and executed by the processor. Therefore, the present disclosure can also be implemented as a program that can be executed by the processor or a non-transitory computer-readable medium that stores the program.

Some embodiments of the present disclosure will be described below by way of example. However, it should be noted that the embodiments of the present disclosure are not limited thereto.

### APPENDIX 1

A method executed by an information processing device to assign to a target vehicle a task of delivering loads stored in a warehouse and addressed to a target consignee to the target consignee, the method including executing an assignment process including:
determining whether a load amount of the loads is equal to or more than a reference amount;
when the load amount is determined to be equal to or more than the reference amount, assigning the task to the target vehicle;
when the load amount is determined to be less than the reference amount, determining whether a target time as a time from a predicted end time of the task to an operation end time of the target vehicle is within a reference time;
when the target time is determined to be within the reference time, assigning the task to the target vehicle; and
when the target time is determined not to be within the reference time, withholding assignment of the task to the target vehicle.

### APPENDIX 2

The method according to appendix 1, in which
when assigning the task to the target vehicle, the information processing device is configured to assign the task to the target vehicle when the predicted end time of the task is included in a reception time slot set for the target consignee.

### APPENDIX 3

The method according to appendix 1 or 2, in which
when assigning the task to the target vehicle, the information processing device is configured to withhold assignment of the task to the target vehicle when the predicted end time is not included in the reception time slot.

### APPENDIX 4

The method according to any one of appendices 1 to 3, in which:
the assignment process further includes, when the load amount is determined to be less than the reference amount, determining whether the load amount is equal to or more than a minimum loading capacity of the target vehicle; and
when the load amount is determined to be equal to or more than the minimum loading capacity, the information processing device is configured to determine whether the target time is within the reference time.

### APPENDIX 5

The method according to any one of appendices 1 to 4, in which
the assignment process further includes, when the load amount is determined to be less than the minimum loading capacity, withholding assignment of the task to the target vehicle.

### APPENDIX 6

The method according to any one of appendices 1 to 5, in which:
the assignment process further includes
selecting one of a plurality of delivery vehicles as the target vehicle, and
when assignment of the task to the target vehicle is withheld, selecting from the delivery vehicles a delivery vehicle with a highest vehicle rank next to the target vehicle as a new target vehicle; and
the information processing device is configured to execute the assignment process for the new target vehicle.

### APPENDIX 7

The method according to any one of appendices 1 to 6, in which:
the assignment process further includes
selecting one of a plurality of consignees as the target consignee, and
when assignment of the task to the target vehicle is withheld, selecting from the consignees a consignee with a largest load amount of loads stored in the warehouse next to the target consignee as a new target consignee; and
the information processing device is configured to execute the assignment process for the new target consignee.

### APPENDIX 8

An information processing device that assigns to a target vehicle a task of delivering loads stored in a warehouse and addressed to a target consignee to the target consignee, the information processing device including a control unit configured to execute an assignment process including:
determining whether a load amount of the loads is equal to or more than a reference amount;
when the load amount is determined to be equal to or more than the reference amount, assigning the task to the target vehicle;
when the load amount is determined to be less than the reference amount, determining whether a target time as a time from a predicted end time of the task to an operation end time of the target vehicle is within a reference time;
when the target time is determined to be within the reference time, assigning the task to the target vehicle; and
when the target time is determined not to be within the reference time, withholding assignment of the task to the target vehicle.

### APPENDIX 9

The information processing device according to appendix 8, in which
when assigning the task to the target vehicle, the control unit is configured to assign the task to the target vehicle when the predicted end time of the task is included in a reception time slot set for the target consignee.

### APPENDIX 10

The information processing device according to appendix 8 or 9, in which
when assigning the task to the target vehicle, the control unit is configured to withhold assignment of the task to the target vehicle when the predicted end time is not included in the reception time slot.

### APPENDIX 11

The information processing device according to any one of appendices 8 to 10, in which:
the assignment process further includes, when the load amount is determined to be less than the reference amount, determining whether the load amount is equal to or more than a minimum loading capacity of the target vehicle; and
when the load amount is determined to be equal to or more than the minimum loading capacity, the control unit is configured to determine whether the target time is within the reference time.

### APPENDIX 12

The information processing device according to any one of appendices 8 to 11, in which
the assignment process further includes, when the load amount is determined to be less than the minimum loading capacity, withholding assignment of the task to the target vehicle.

### APPENDIX 13

The information processing device according to any one of appendices 8 to 12, in which:
the assignment process further includes
selecting one of a plurality of delivery vehicles as the target vehicle, and
when assignment of the task to the target vehicle is withheld, selecting from the delivery vehicles a delivery vehicle with a highest vehicle rank next to the target vehicle as a new target vehicle; and
the control unit is configured to execute the assignment process for the new target vehicle.

### APPENDIX 14

The information processing device according to any one of appendices 8 to 13, in which:
the assignment process further includes
selecting one of a plurality of consignees as the target consignee, and
when assignment of the task to the target vehicle is withheld, selecting from the consignees a consignee with a largest load amount of loads stored in the warehouse next to the target consignee as a new target consignee; and
the control unit is configured to execute the assignment process for the new target consignee.

### APPENDIX 15

A program that causes an information processing device to execute an assignment process, the information processing device assigning to a target vehicle a task of delivering loads stored in a warehouse and addressed to a target consignee to the target consignee, the assignment process including:
determining whether a load amount of the loads is equal to or more than a reference amount;
when the load amount is determined to be equal to or more than the reference amount, assigning the task to the target vehicle;
when the load amount is determined to be less than the reference amount, determining whether a target time as a time from a predicted end time of the task to an operation end time of the target vehicle is within a reference time;
when the target time is determined to be within the reference time, assigning the task to the target vehicle; and
when the target time is determined not to be within the reference time, withholding assignment of the task to the target vehicle.

### APPENDIX 16

The program according to appendix 15, in which
when assigning the task to the target vehicle, the information processing device is configured to assign the task to the target vehicle when the predicted end time of the task is included in a reception time slot set for the target consignee, and to withhold assignment of the task to the target vehicle when the predicted end time is not included in the reception time slot.

### APPENDIX 17

The program according to appendix 15 or 16, in which:
the assignment process further includes, when the load amount is determined to be less than the reference amount, determining whether the load amount is equal to or more than a minimum loading capacity of the target vehicle; and
when the load amount is determined to be equal to or more than the minimum loading capacity, the information processing device is configured to determine whether the target time is within the reference time.

### APPENDIX 18

The program according to any one of appendices 15 to 17, in which
the assignment process further includes, when the load amount is determined to be less than the minimum loading capacity, withholding assignment of the task to the target vehicle.

### APPENDIX 19

The program according to any one of appendices 15 to 18, in which:
the assignment process further includes
selecting one of a plurality of delivery vehicles as the target vehicle, and
when assignment of the task to the target vehicle is withheld, selecting from the delivery vehicles a delivery vehicle with a highest vehicle rank next to the target vehicle as a new target vehicle; and
the information processing device is configured to execute the assignment process for the new target vehicle.

### APPENDIX 20

The program according to any one of appendices 15 to 19, in which:
the assignment process further includes
selecting one of a plurality of consignees as the target consignee, and
when assignment of the task to the target vehicle is withheld, selecting from the consignees a consignee with a largest load amount of loads stored in the warehouse next to the target consignee as a new target consignee; and
the information processing device is configured to execute the assignment process for the new target consignee.

What is claimed is:

1. A method executed by an information processing device to assign to a target vehicle a task of delivering loads stored in a warehouse and addressed to a target consignee to the target consignee, the method comprising executing an assignment process including:
determining whether a load amount of the loads is equal to or more than a reference amount;
when the load amount is determined to be equal to or more than the reference amount, assigning the task to the target vehicle;
when the load amount is determined to be less than the reference amount, determining whether a target time as a time from a predicted end time of the task to an operation end time of the target vehicle is within a reference time;
when the target time is determined to be within the reference time, assigning the task to the target vehicle; and
when the target time is determined not to be within the reference time, withholding assignment of the task to the target vehicle.

2. The method according to claim 1, wherein when assigning the task to the target vehicle, the information processing device is configured to assign the task to the target vehicle when the predicted end time of the task is included in a reception time slot set for the target consignee.

3. The method according to claim 2, wherein when assigning the task to the target vehicle, the information processing device is configured to withhold assignment of the task to the target vehicle when the predicted end time is not included in the reception time slot.

4. The method according to claim 1, wherein:
the assignment process further includes, when the load amount is determined to be less than the reference amount, determining whether the load amount is equal to or more than a minimum loading capacity of the target vehicle; and
when the load amount is determined to be equal to or more than the minimum loading capacity, the information processing device is configured to determine whether the target time is within the reference time.

5. The method according to claim 4, wherein the assignment process further includes, when the load amount is determined to be less than the minimum loading capacity, withholding assignment of the task to the target vehicle.

6. The method according to claim 1, wherein:
the assignment process further includes
selecting one of a plurality of delivery vehicles as the target vehicle, and
when assignment of the task to the target vehicle is withheld, selecting from the plurality of delivery vehicles a delivery vehicle with a highest vehicle rank next to the target vehicle as a new target vehicle; and
the information processing device is configured to execute the assignment process for the new target vehicle.

7. The method according to claim 1, wherein:
the assignment process further includes
selecting one of a plurality of consignees as the target consignee, and
when assignment of the task to the target vehicle is withheld, selecting from the plurality of consignees a consignee with a largest load amount of loads stored in the warehouse next to the target consignee as a new target consignee; and
the information processing device is configured to execute the assignment process for the new target consignee.

8. An information processing device that assigns to a target vehicle a task of delivering loads stored in a warehouse and addressed to a target consignee to the target consignee, the information processing device comprising a control unit configured to execute an assignment process including:
determining whether a load amount of the loads is equal to or more than a reference amount;
when the load amount is determined to be equal to or more than the reference amount, assigning the task to the target vehicle;
when the load amount is determined to be less than the reference amount, determining whether a target time as a time from a predicted end time of the task to an operation end time of the target vehicle is within a reference time;
when the target time is determined to be within the reference time, assigning the task to the target vehicle; and
when the target time is determined not to be within the reference time, withholding assignment of the task to the target vehicle.

9. The information processing device according to claim 8, wherein when assigning the task to the target vehicle, the control unit is configured to assign the task to the target vehicle when the predicted end time of the task is included in a reception time slot set for the target consignee.

10. The information processing device according to claim 9, wherein when assigning the task to the target vehicle, the control unit is configured to withhold assignment of the task to the target vehicle when the predicted end time is not included in the reception time slot.

11. The information processing device according to claim 8, wherein:
the assignment process further includes, when the load amount is determined to be less than the reference amount, determining whether the load amount is equal to or more than a minimum loading capacity of the target vehicle; and
when the load amount is determined to be equal to or more than the minimum loading capacity, the control unit is configured to determine whether the target time is within the reference time.

12. The information processing device according to claim 11, wherein the assignment process further includes, when the load amount is determined to be less than the minimum loading capacity, withholding assignment of the task to the target vehicle.

13. The information processing device according to claim 8, wherein:
the assignment process further includes
selecting one of a plurality of delivery vehicles as the target vehicle, and
when assignment of the task to the target vehicle is withheld, selecting from the plurality of delivery vehicles a delivery vehicle with a highest vehicle rank next to the target vehicle as a new target vehicle; and
the control unit is configured to execute the assignment process for the new target vehicle.

14. The information processing device according to claim 8, wherein:
the assignment process further includes
selecting one of a plurality of consignees as the target consignee, and
when assignment of the task to the target vehicle is withheld, selecting from the plurality of consignees a consignee with a largest load amount of loads stored in the warehouse next to the target consignee as a new target consignee; and
the control unit is configured to execute the assignment process for the new target consignee.

15. A program that causes an information processing device to execute an assignment process, the information processing device assigning to a target vehicle a task of delivering loads stored in a warehouse and addressed to a target consignee to the target consignee, the assignment process comprising:
determining whether a load amount of the loads is equal to or more than a reference amount;
when the load amount is determined to be equal to or more than the reference amount, assigning the task to the target vehicle;
when the load amount is determined to be less than the reference amount, determining whether a target time as a time from a predicted end time of the task to an operation end time of the target vehicle is within a reference time;
when the target time is determined to be within the reference time, assigning the task to the target vehicle; and
when the target time is determined not to be within the reference time, withholding assignment of the task to the target vehicle.

16. The program according to claim 15, wherein when assigning the task to the target vehicle, the information processing device is configured to assign the task to the target vehicle when the predicted end time of the task is included in a reception time slot set for the target consignee, and to withhold assignment of the task to the target vehicle when the predicted end time is not included in the reception time slot.

17. The program according to claim 15, wherein:
the assignment process further includes, when the load amount is determined to be less than the reference amount, determining whether the load amount is equal to or more than a minimum loading capacity of the target vehicle; and
when the load amount is determined to be equal to or more than the minimum loading capacity, the information processing device is configured to determine whether the target time is within the reference time.

18. The program according to claim 17, wherein the assignment process further includes, when the load amount is determined to be less than the minimum loading capacity, withholding assignment of the task to the target vehicle.

19. The program according to claim 15, wherein:
the assignment process further includes
selecting one of a plurality of delivery vehicles as the target vehicle, and
when assignment of the task to the target vehicle is withheld, selecting from the plurality of delivery vehicles a delivery vehicle with a highest vehicle rank next to the target vehicle as a new target vehicle; and
the information processing device is configured to execute the assignment process for the new target vehicle.

20. The program according to claim 15, wherein:
the assignment process further includes
selecting one of a plurality of consignees as the target consignee, and
when assignment of the task to the target vehicle is withheld, selecting from the plurality of consignees a consignee with a largest load amount of loads stored in the warehouse next to the target consignee as a new target consignee; and
the information processing device is configured to execute the assignment process for the new target consignee.
